(19) United States
(12) Patent Application Publication
(10) Pub. No.: US 2002/0178872 A1
(43) Pub. Date: Dec. 5, 2002

(54) Varying sized thru socket attachement system with hand wrench

(76) Inventor: Joseph Ferrantelli, Staten Island, NY (US)

Correspondence Address: Richard W. Goldstein, 2071 Clove Road, Staten Island, NY, 10304, US

(21) Appl. No.: 09/871,846

(22) Filed: Jun. 1, 2001

(51) Int. Cl. B25B 13/00

(52) U.S. Cl. 81/124.3

(57) ABSTRACT

Varying sized thru socket attachments with a hand wrench, the wrench having a handle and a head. Each socket attachment has a neck and a receiving shoulder. The neck has an outer perimeter in the shape of a polygon which is coupled with the head of the wrench for a secure fit. A channel extends fully through the attachment through both the neck and shoulder. The size of the channel varies for the different attachment, while the diameter of the neck and the outer wall of the shoulder portion remain constant so as to properly engage the wrench. Thus, the same wrench may be employed with all attachments and used to loosen or tighten any sized nut.

### BACKGROUND OF THE INVENTION

The invention relates to a varying sized thru socket attachment system with a hand wrench. In particular, the invention is a wrench that may be coupled with a plurality of standard sized thru socket attachments, wherein each socket attachment has a different sized center channel for engaging different sized workpieces, namely nuts.

Hand tools are instruments that allow a user to manipulate a workpiece. Such tools are necessary to enable one to loosen or tighten workpieces that would not otherwise be possible with one's bare hands. Wrenches, in particular, are typically used to loosen or tighten a nut around a bolt. A nut is a thin hexagonal piece that is screwed onto a bolt in order to hold the bolt in place about a workpiece.

A standard socket has an opening for accepting a workpiece on one side and has a drive opening on the opposite side. Thus, a standard socket wrench can extend only as far onto the workpiece as the depth of the socket allows. There are many applications where it would be helpful to have the socket extend further downward onto the shaft of the workpiece in order to manipulate a nut.

U.S. Pat. No. 6,148,694 to Spirer discloses a hand wrench with torque augmenting means. It includes a linkage assembly to join a drive input with an output wrench socket.

U.S. Pat. No. 5,636,557 to Ma discloses a ratchet type ring spanner having a handle, a head portion, and a ratchet wheel.

Thus, there exists a need for a device which would enable a user to manipulate a workpiece regardless of its depth. Such a device would allow one to extend the wrench as far as necessary while using an attachment to fit around the workpiece to be loosened or tightened.

While the available units may be suitable for the particular purpose employed, or for general use, they would not be as suitable for the purposes of the present invention as disclosed hereafter.

### SUMMARY OF THE INVENTION

In view of the foregoing disadvantages inherent in the prior art, the present invention provides an improved varying sized thru socket attachment system with a hand wrench. As such, the general purpose of the present invention, which will be described subsequently in greater detail, is to provide a new and improved varying sized thru socket attachments with a hand wrench which has all the advantages of the prior art and none of the disadvantages.

To attain this, the present invention essentially comprises a hand wrench with varying sized thru socket attachments, the wrench having a handle and a head. Each socket attachment has a neck and a receiving shoulder. The neck has an outer perimeter in the shape of a polygon which is coupled with the head of the wrench for a secure fit. A channel extends fully through the attachment through both the neck and shoulder. The size of the channel varies for the different attachments, while the diameter of the neck and the outer wall of the shoulder portion remain constant so as to properly engage the wrench. Thus, the same wrench may be employed with all attachments and used to loosen or tighten any sized nut.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved varying sized thru socket attachment system with a hand wrench which has many essential advantages of the prior art and none of their disadvantages.

It is another object of the present invention to provide a new and improved varying sized thru socket attachment system with a hand wrench which may be easily and efficiently manufactured and marketed.

It is a further object of the present invention to provide a new and improved varying sized thru socket attachment system with a hand wrench which is of durable and reliable construction.

An even further object of the present invention is to provide a new and improved varying sized thru socket attachment system with a hand wrench which is susceptible to a low cost of manufacture with regard to both materials and labor, and which accordingly is then susceptible of low prices of sale to the consuming public, thereby making such a varying sized thru socket attachment system with a hand wrench economically available to the buying public.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a perspective view of a wrench with a socket attachment positioned for insertion into said wrench.

FIG. 2 is a perspective view of a standard wrench.

FIG. 3 is a perspective view of the wrench with the socket attachment secured therein.

FIG. 4 is a cross sectional view of the socket attachment.

FIG. 5 is a cross-sectional view of three different sized socket attachments.

### DETAILED DESCRIPTION OF THE PREFERRED EMBODIMENTS

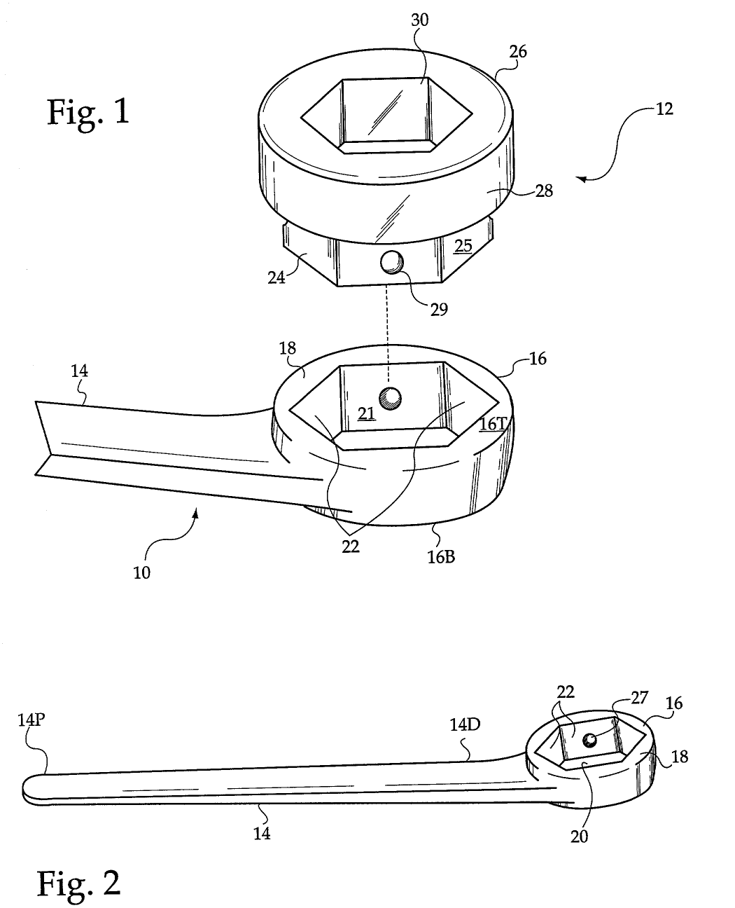

FIG. 1 illustrates a hand wrench 10 with a socket attachment 12 positioned thereover for engagement with said wrench 10. As shown in FIG. 2, the wrench 10 comprises a handle portion 14, having a proximal end 14P and a distal end 14D, and a head 16, having a top surface 16T and a bottom surface 16B. The head 16 includes an outer circular peripheral wall 18 defining a wrench thru channel 20 for receiving the attachment 12. The channel 20 extends from the head's top surface 16T to the bottom surface 16B. The head 16 is connected to the distal end 14D of the handle portion 14. The wrench thru channel 20 is defined by a plurality of angled walls 22 in the shape of a polygon, namely a hexahedron, that protrude from the peripheral wall 18. This channel 20 has an interior surface 21.

Referring back to FIG. 1, the socket attachment 12 comprises a neck 24 and a receiving shoulder portion 26. The neck 24 has an outer surface 25 shaped and sized substantially the same as the thru channel 20 for coupling the attachment 12 with the wrench head 16. The shoulder portion 26 has a larger diameter than the neck 24. Thus, when the attachment 12 is mated with the wrench head 16, the shoulder portion 26 rests against the top surface 16T of said wrench head 16.

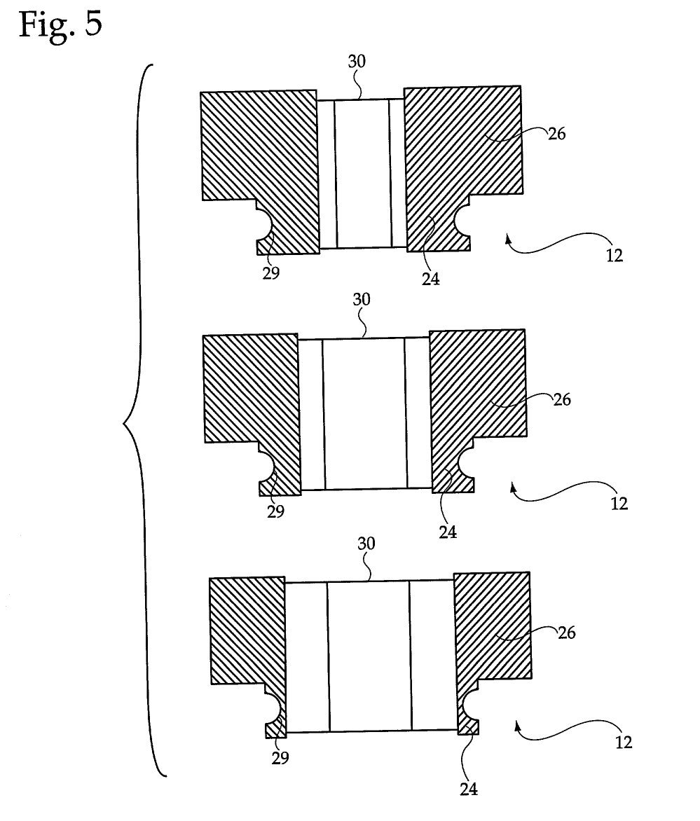

Similar to the wrench's head 16, the shoulder portion 26 of the socket attachment 12 comprises an outer wall 28 surrounding a central channel 30, which extends through both the neck 24 and the shoulder 26. This central channel 30 has a uniform cross section through both the neck 24 and the shoulder portion 26, as illustrated in FIG. 5. A plurality of socket attachments 12 are available for use with different sized nuts. The size of the central channel 30 of each attachment 12 differs, while the diameter of the neck 24 and the outer wall 28 of the shoulder portion 26 remain constant. FIG. 5 illustrates three socket attachments 12, each having a different sized central channel 30. Thus, the same wrench 10 may be employed with all attachments 12.

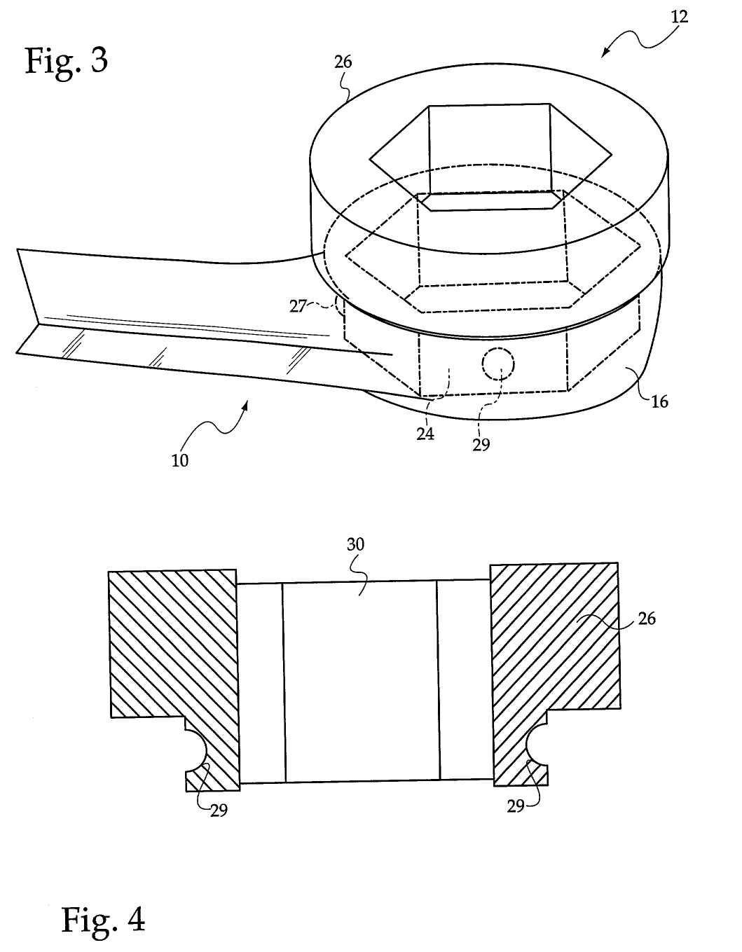

A small protrusion 27 is situated on the interior surface 21 of the wrench thru channel 20. When coupled with the head 16 of the wrench 10, the neck 24 is inserted into the wrench thru channel 20, between the peripheral wall 18, as shown in FIG. 3. The diameter of the neck 24 is substantially the same size as the wrench thru channel 20 in order to allow for a tight fit therein. A plurality of indentations 29 are situated along the outer surface of the neck 24, said indentations 29 are mateable with the protrusion 27 in the wrench thru channel 20.

In operation, the appropriate sized socket attachment 12 is chosen according to the size of a workpiece (not shown), namely a nut, to be loosened or tightened. The neck 24 is then inserted into the wrench thru channel 20 by placing pressure on the shoulder portion 26 and forcing the protrusion 27 into one of the indentations 29. One may then proceed to hold the wrench 10 by the proximal end 14P of the handle portion 14, and manipulate the wrench 10 over the shaft of the workpiece in order to reach the nut. Because of the positioning of the nut, it may be necessary to slide the wrench 10, with attachment 12, over a screw or piping in order to have access to said nut, with the screw or piping extending through the central channel 30 of the attachment and the wrench thru channel 20. The wrench 10 is then rotated about the nut in either a clockwise or counterclockwise direction.

In conclusion, herein is presented a varying sized thru socket attachment system with a hand wrench. The invention is illustrated by example in the drawing figures, and throughout the written description. It should be understood that numerous variations are possible, while adhering to the inventive concept. Such variations are contemplated as being a part of the present invention.

What is claimed is:

1. A socket wrench system, comprising:
a wrench having a handle portion and head, the head having a top surface, a bottom surface, and an outer cylindrical peripheral wall extending therebetween, said wall defining a wrench thru channel defined by with a plurality of angled walls in the shape of a polygon, said channel extending fully from the top surface to the bottom surface and having an interior surface; and
at least two socket attachments, each having a neck and a receiving shoulder portion, the neck having an outer surface shaped and sized substantially the same as the thru channel for coupling the attachment with the head of the wrench, each attachment having a central channel extending through both the neck and shoulder portion.

2. The socket wrench system as recited in claim 1, wherein the shoulder portion of each attachment is larger diametrically than the neck such that when said attachment is mated with the wrench head the shoulder rests against the top surface.

3. The socket wrench system as recited in claim 2, wherein the diameter of the central channel of two of said socket attachments have different diameters while the diameter of the neck and shoulder portion are the same for both of said sockets.

4. The socket wrench system as recited in claim 3, wherein the wrench comprises a protrusion positioned on the interior surface of the thru channel, wherein each attachment has a plurality of indentations extending into the outer surface of the neck, and wherein said protrusion is mateable with one of the indentations to allow the socket attachment to be secured in place within the wrench thru channel.

5. The socket wrench system as recited in claim 4, wherein the central channel has a uniform cross section through both the neck and shoulder portion.

6. A socket wrench method for manipulating a workpiece having an outside surface having a workpiece polygonal shape, using a wrench having a handle portion and a head, the head having a top surface, a bottom surface, and a thru channel extending fully therebetween, comprising the steps of:
providing a socket attachment having a neck and shoulder, the neck sized to fit within the wrench thru channel with the shoulder portion resting against the head top surface, the attachment having a central channel shaped like the outside surface of the workpiece;
mating the socket attachment with the wrench head by inserting the neck into the wrench thru channel;
engaging the workpiece outside surface with the central channel of the socket attachment by inserting the workpiece through the central channel; and
manipulating the workpiece by turning the handle portion.

7. The socket wrench method as recited in claim 6, wherein the wrench comprises a protrusion positioned on the interior surface of the thru channel, and each attachment has a plurality of indentations extending into the outer surface of the neck, wherein the step of mating the socket attachment with the wrench head further comprises mating the protrusion with one of the indentations.
